(19) United States
(12) Patent Application Publication
(10) Pub. No.: US 2013/0337793 A1
(43) Pub. Date: Dec. 19, 2013

(54) BUNDLED MOBILE DEVICE PURCHASE SYSTEM

(71) Applicants: GYAN PRAKASH, Beaverton, OR (US); REINHARD R. STEFFENS, Santa Clara, CA (US); SHAHROKH SHAHRO SHAHIDZADEH, Portland, OR (US); VENKATESH RAMAMURTHY, Hillsboro, OR (US); RAJESH POORNACHANDRAN, Portland, OR (US)

(72) Inventors: GYAN PRAKASH, Beaverton, OR (US); REINHARD R. STEFFENS, Santa Clara, CA (US); SHAHROKH SHAHRO SHAHIDZADEH, Portland, OR (US); VENKATESH RAMAMURTHY, Hillsboro, OR (US); RAJESH POORNACHANDRAN, Portland, OR (US)

(21) Appl. No.: 13/525,210

(22) Filed: Jun. 15, 2012

(51) Int. Cl. H04W 8/22

(52) U.S. Cl. CPC H04W 8/22
USPC 455/418

(57) ABSTRACT

Generally, this disclosure relates to a bundled mobile device purchase system. The system may include a mobile device and a bundle service. The mobile device may include transponder circuitry configured to receive and store a bundle identifier including an application identifier related to an application, the bundle identifier provided to the transponder circuitry during a transaction that includes purchasing the mobile device and the application. The mobile device may further include memory circuitry configured to receive and store the application after the transaction. The bundle service may include a bundle download module configured to provide the application to the mobile device in response to receiving the application identifier from the mobile device.

### FIELD

This disclosure relates to a mobile device purchase system, more particularly a bundled mobile device purchase system.

### BACKGROUND

A user may purchase a mobile device (e.g., a smartphone) and may later purchase one or more applications (“apps”) for the mobile device. Apps may be purchased from app sources, for example, an app store. Such purchases typically require configuration of the mobile device with user's personal data such as e-mail, credit card etc, access to the app store, selection of the app, payment for the app and download of the app to the mobile device. Thus, purchasing an app for the mobile device is typically separate and disconnected from the purchase of the mobile device.

In some situations, an OEM/ODM (Original Equipment Manufacturer/Original Device Manufacturer) may preload one or more apps on a mobile device prior to purchase by an end-user. The preloaded apps are generally selected by the OEM/ODM and may not reflect the end-user's preferences.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a bundled mobile device purchase system consistent with various embodiments of the present disclosure;

FIG. 2 illustrates a flowchart of exemplary operations for purchasing a bundled mobile device consistent with an embodiment of the present disclosure; and

FIG. 3 illustrates a flowchart of exemplary operations for downloading app(s), service(s) and/or rewards to a mobile device consistent with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a bundled mobile device purchase system. An apparatus, system and method consistent with the present disclosure are configured to allow purchase of applications (“apps”) and/or services and/or acceptance of rewards during a transaction to purchase a mobile device (i.e., “bundled” with the mobile device). The reseller may then store a bundle identifier (“bundle ID”) related to the product bundle in the purchased mobile device. For example, the bundle ID may include an identifier associated with each app, service and/or reward. The bundle ID may further include user purchase details. User purchase details may include, but are not limited to, a unique purchase identifier such as a sales receipt number. The bundle ID may be stored in the mobile device without powering up (i.e., powering on) the mobile device by the reseller. For example, the bundle ID may be stored in the mobile device without removing the mobile device from its packaging (i.e., “new, in box”). The apps, services and/or rewards may then be downloaded to the mobile device (from, for example, the cloud) and/or offered to the user after the purchase transaction, for example, in response to mobile device power up (e.g., initial mobile device power up by the user), in response to a user request and/or in response to update(s) to app(s), service(s) and/or reward(s).

Apps may include, but are not limited to, educational apps, entertainment apps (e.g., games), informational apps (e.g., news, weather, personal navigation), health related apps (e.g., diet, exercise) and/or other apps known to those skilled in the art. Services may include, but are not limited to, cellular telephone service, internet service, discounted media content subscriptions, opening an online bank account with cash award, security (e.g., home, vehicle), navigation, information and/or other services known to those skilled in the art. Rewards may include, but are not limited to, rewards for purchasing app(s) and/or service(s), reward offers for later purchases of app(s) and/or service(s), coupons, gift cards and/or other rewards known to those skilled in the art.

Thus, a reseller may offer app(s), service(s) and/or reward(s) to a user during a mobile device purchase transaction by the user. The user may select one or more app(s) and/or service(s) for purchase with the mobile device. The user may further agree to accept one or more rewards (e.g., coupons) associated with the purchase of app(s), service(s) and/or the mobile device.

In this manner, sales and marketing channels for apps, for example, may be expanded to include resellers. A user that purchases a mobile device may benefit from customized selection of apps, services and rewards and thus avoid undesired apps, services and rewards. The user may further benefit by selecting the product bundle during the mobile device purchase transaction and the reseller may offer incentives to the user based on, e.g., a number of apps and/or services purchased and/or rewards accepted. Use of the bundle ID with later download/activation of app(s), service(s) and/or reward(s) is configured to allow the reseller to store the user selected/accepted app, service and/or reward identifiers in the mobile device without requiring powering up the mobile device.

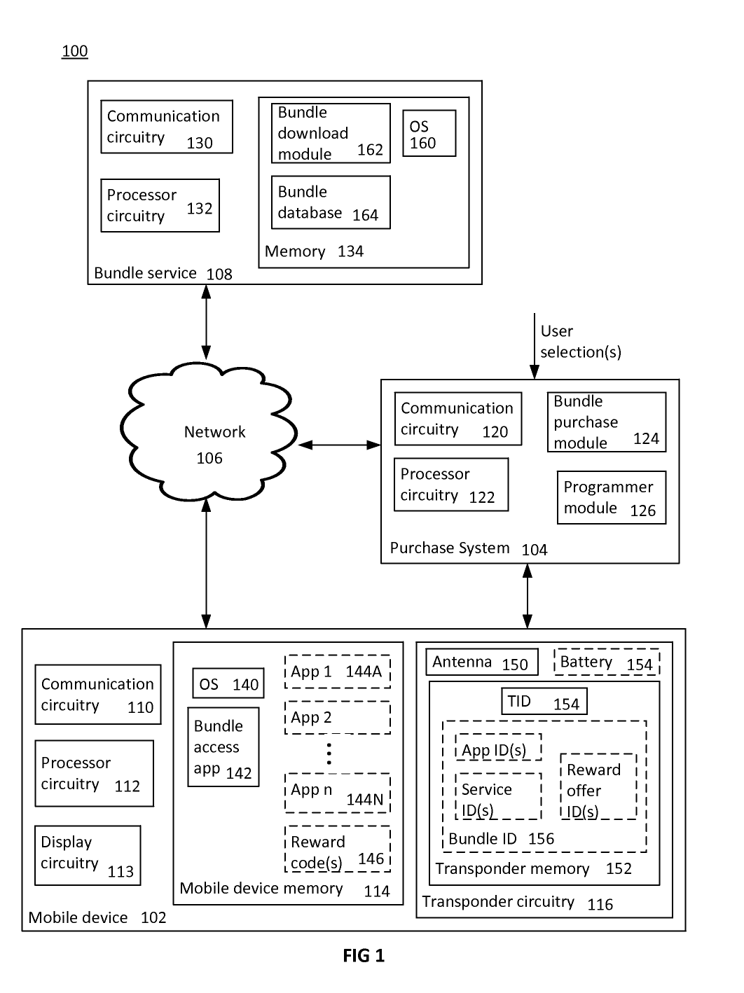

FIG. 1 illustrates a bundled mobile device purchase system 100 consistent with various embodiments of the present disclosure. The system 100 generally includes a mobile device 102, a purchase system 104, a network 106 and a bundle service 108. “Mobile device” as used herein means any handheld computing device configured to download and execute an app, including, but not limited to, mobile telephones, smartphones, feature phones, tablet computers, ultraportable computers, ultramobile computers, netbook computers, subnotebook computers, personal digital assistants, enterprise digital assistants, mobile internet devices and personal navigation devices.

Mobile device 102 and purchase system 104 include communication circuitry 110 and 120, respectively, and processor circuitry 112 and 122, respectively. Communication circuitry 110 and 120 are configured to transmit and receive one or more signals that comply and/or are compatible with one or more communication protocols. As used herein, signals and/or communication protocols include but are not limited to NFC (Near Field Communication), RFID (Radio frequency identification), Bluetooth, Wi-Fi, 3G, 4G and/or other communication protocols. Mobile device 102 and purchase system 104 are configured to communicate via one or more of these communication protocols. For example, purchase system 104 may be configured to communicate with mobile device 102 using NFC or RFID to provide the bundle ID to the mobile device 102. In another example, purchase system 104 and/or mobile device 102 may be configured to communicate with bundle service 108 via network 106 using, e.g., Wi-Fi. Processor circuitry 112 is configured to perform operations associated with one or more applications included in mobile device 102. Processor circuitry 122 is configured to perform operations associated with purchase system 104.

Mobile device 102 includes display circuitry 113, memory 114 and transponder circuitry 116. Display circuitry 113 is configured to display information to the user as described herein. Display circuitry may be further configured to receive user inputs. For example, display circuitry may include a touch screen. Mobile device memory 114 is configured to store mobile device operating system (OS 140, bundle access app 142 and one or more app(s) 144A, . . . , 144N and/or reward code(s) 146.

Transponder circuitry 116 includes an antenna 150 and transponder memory 152. Transponder memory 152 is configured to store a transponder identifier TID 154 and a bundle identifier (“bundle ID”) 156. For example, transponder circuitry 116 may be an RFID module. In another example, transponder circuitry 116 may be an NFC module. In some embodiments, transponder circuitry 116 may include a battery 153. The battery 153 is configured to provide power to communication circuitry 110, if, for example, purchase system 104 provides the bundle ID 156 to the mobile device using Wi-Fi, 3G or 4G.

At manufacturing, mobile device 102 may be configured without app(s) 144A, . . . , 144N, without reward codes 146 and without bundle ID 156. Mobile device 102 may be provisioned with TID 154 (e.g., device serial number) configured to uniquely identify mobile device 102. A reseller may utilize purchase system 104 to generate the bundle ID based, at least in part, on user selections of bundled product during the purchase transaction of mobile device 102. For example, a reseller may be a physical entity (i.e., “bricks and mortar”) so that the user/purchaser is local to the purchase system 104 during the purchase transaction. In another example, the reseller may be accessed by a user/purchaser remotely via a network, e.g., network 106.

The user may select one or more app(s) and/or service(s) for purchase during the transaction to purchase the mobile device 102. The user may be offered one or more reward(s) during the transaction. The reward(s) may be related to the app(s), service(s) and/or mobile device purchased and/or may be related to possible future purchases. The user may choose to accept or reject offered reward(s). Each app, service and reward may be identified by a unique identifier. For example, each identifier may be numeric. In another example, one or more identifiers may be alpha numeric. The bundle ID 156 may then be generated based, at least in part, on the app, service and reward identifiers. For example, the bundle ID 156 may include a concatenation of the app, service and reward identifiers. In some embodiments, the bundle ID 156 may further include an indicator of the number of app(s) and/or service(s) purchased. In some embodiments, the bundle ID 156 may further include a unique purchase identifier, for example, a sales receipt number. In some embodiments, at least some identifiers may be configured to allow a user to select which app(s) to download and/or which service(s) to activate, as described herein.

Purchase system 104 includes a bundle purchase module 124 and a programmer module 126. Purchase system 104 is configured to provide the bundle ID to transponder circuitry 116. Purchase system 104 may be temporarily coupled to transponder circuitry 116 in order to provide the bundle ID 156 to transponder circuitry 116. For example, the purchase system 104 may be configured to communicate wirelessly with transponder circuitry 116 via antenna 150. Such wireless communication may include NFC (Near Field Communication), RFID, Bluetooth and/or other communication protocols.

Bundle purchase module 124 is configured to receive user selection(s) during the mobile device 102 purchase transaction. The bundle purchase module 124 is then configured to generate the bundle ID 156 and to provide the bundle ID 156 to the mobile device 102 using the programmer module 126. Bundle purchase module 124 may be configured to provide a listing of available app(s) and/or service(s) to the user and to receive the user's selection(s). The bundle purchase module 124 may be further configured to provide reward offer(s) to the user based on, for example, the app(s) and/or service(s) selected for purchase and/or characteristics of the mobile device 102. In some embodiments, the app(s) and/or service(s) may be related to the mobile device 102.

Thus, one or more app(s) and/or service(s) may be purchased during a transaction to purchase a mobile device, e.g., mobile device 102. One or more reward(s) may be offered during this purchase transaction. A bundle ID may then be generated configured to identify the purchased app(s) and/or service(s) and accepted reward(s). The bundle ID may further include a unique purchase identifier. The bundle ID may then be stored in the purchased mobile device using, for example, NFC and/or RFID, enabling storage in the mobile device without powering up the mobile device. Thus, app and service purchases may be combined with the purchase of the mobile device at a reseller. The app(s) and service(s) purchased may be generally user-selected based on user preferences, avoiding apps and services not desired by the user.

After the bundle ID 156 has been stored in the mobile device 102 by the reseller, the mobile device may be provided to the user. If the purchase transaction was performed locally, the user may be provided the mobile device at the reseller's location. If the purchase transaction was performed remotely, the mobile device 102, including bundle ID 156 stored in the transponder memory 152, may be shipped to the user. The purchased app(s) may then be downloaded to the mobile device 102, the purchased service(s) may then be activated and/or the accepted reward(s) may be redeemed after receipt of the mobile device 102 by the user. In response to mobile device 102 being powered up and/or in response to a user selection, bundle access app 142 may be configured to execute to couple mobile device 102 to bundle service 108 via, for example, network 106.

Bundle service 108 may include communication circuitry 130, one or more processor(s) (“processor circuitry”) 132, and memory 134. Bundle service 108 may correspond to one or more servers in a plurality of servers, i.e., may be in the cloud. Processor circuitry 132 is configured to perform operations associated with system 100 and bundle service 108. Communication circuitry 130 is configured to communicate, wired and/or wirelessly, with mobile device 102 and/or purchase system 104 via network 106, using one or more communication protocols, as described herein. The communication protocols may include, but are not limited to, Wi-Fi, Bluetooth, 3G, 4G and/or some other communication protocol.

Bundle service memory 134 may include operating system OS 160, bundle download module 162 and bundle database 164. Bundle download module 162 is configured to manage download of purchased app(s) and accepted reward(s) to mobile device 102 and activation of purchased service(s) in response to a request from bundle access app 142. Bundle download module 162 may be further configured to offer updated app(s), service(s) and/or reward(s) to a user via mobile device 102. Bundle database 164 is configured to store a plurality of app(s) and associated app identifiers, a plurality of service descriptor(s) and associated service identifiers and a plurality of reward offer descriptors and associated reward identifiers (e.g., reward codes).

For example, in response to power up of mobile device 102 and/or a user selection, bundle access app 142 is configured to read the bundle ID 156 from transponder memory 152. Bundle access app 142 is configured to parse the bundle ID 156 to determine the app, service and/or reward identifier(s). Bundle access app 142 may then couple the mobile device 102 to bundle service 108. Bundle access app 142 may then provide the identifiers to the bundle service 108 with a request to download app(s) and/or reward code(s) corresponding to the identifiers and to activate associated services(s).

In some embodiments, bundle access app 142 may be configured to display a listing of app(s), service(s) and/or reward code(s) to the user via display circuitry 113. The user may then select app(s) and/or reward code(s) to download and/or service(s) to activate. The listing may include updated app(s), service(s) and/or reward offer(s) received from bundle service 108.

Bundle download module 162 is configured to receive the request to download app(s) and/or reward code(s) and/or activate service(s) and the identifier(s) from the mobile device 102 (and bundle access app 142). The identifier(s) may include the unique purchase identifier. In response, bundle download module 162 is configured to access the bundle database 164, retrieve app(s) corresponding to received app identifiers and to provide the app(s) to mobile device 102. The app(s) 144A, . . . , 144N may then be stored in mobile device memory 114. Bundle download module 162 may be further configured to retrieve reward code(s) corresponding to reward identifiers and to provide these reward code(s) 146 to mobile device 102. The reward codes 146 may then be stored in mobile device memory 114. Bundle download module 162 may be configured to activate service(s) associated with service identifier(s) included in bundle ID 156 based on associated service descriptors included in bundle database 164. Bundle access app 142 may be further configured to display reward(s) and/or reward code(s) to the user after download to the mobile device.

In some embodiments, purchase system 104 may be configured to couple to bundle service 108 via network 106. For example, purchase system 104 may couple to bundle service 108 to determine available app(s) and/or service(s) and their associated identifier(s). In another example, purchase system 104 may determine available reward offers and associated identifiers. In another example, purchase system 104 may provide information related to a purchase transaction to bundle service 108. In this example, the TID 154 and bundle ID may be provided to the bundle service 108. Communication between purchase system 104 and bundle service 108 may occur separate from the bundled mobile device purchase transaction described herein.

Thus, app(s) and/or service(s) selected and purchased during the mobile device 102 purchase transaction and/or reward offer(s) accepted during the mobile device 102 purchase transaction may be identified using the bundle 156. The bundle ID 156 may be stored in the mobile device 102 during the purchase transaction by a reseller without powering up the mobile device 102. The app(s), service(s) and/or reward code(s) may then be downloaded and/or activated after the purchase transaction.

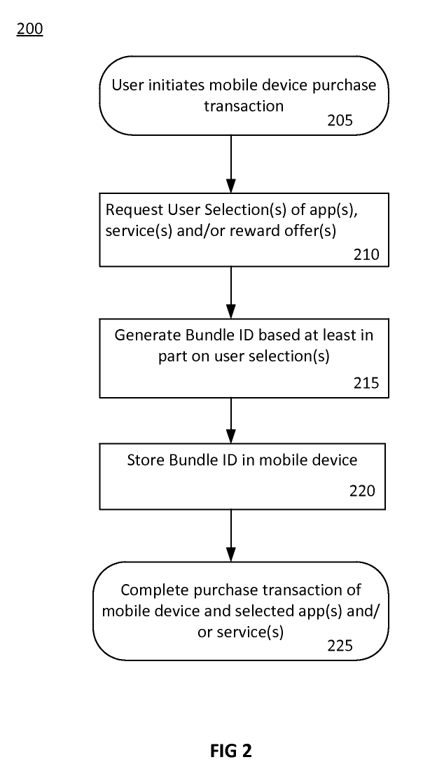

FIG. 2 illustrates a flowchart 200 of exemplary operations consistent with an embodiment of the present disclosure. The operations may be performed, for example, by the purchase system 104. In particular, flowchart 200 depicts exemplary operations configured to allow a user to purchase app(s) and/or service(s) and/or to accept reward offer(s) during a mobile device purchase transaction. The operations of flowchart 200 may begin 205 when a user initiates a mobile device purchase transaction. The user may be requested to select app(s), service(s) and/or reward offer(s). Reward offer(s) may be based, at least in part, on user selection(s) of app(s) and/or service(s). For example, if a user selects a number of app(s), a reward (e.g., gift card) may be offered. Operation 215 includes generating a bundle ID based at least in part on user selection(s). The bundle ID may include app identifiers, service identifiers and/or reward identifiers corresponding to the app(s) and/or service(s) that the user has selected for purchase along with the mobile device and any reward offers that the user has accepted. The bundle ID may further include a unique purchase identifier.

The bundle ID may be stored in the mobile device at operation 220. For example, the bundle ID may be stored in the mobile device by a reseller of the mobile device without powering up the mobile device. Program flow may end at operation 225 with completion of the mobile device purchase transaction. For example, completion of the mobile device purchase transaction may include receiving payment for the mobile device, app(s) and service(s) by the reseller. The mobile device purchase transaction includes selection and purchase of app(s) and/or service(s) and may include offer and acceptance of rewards.

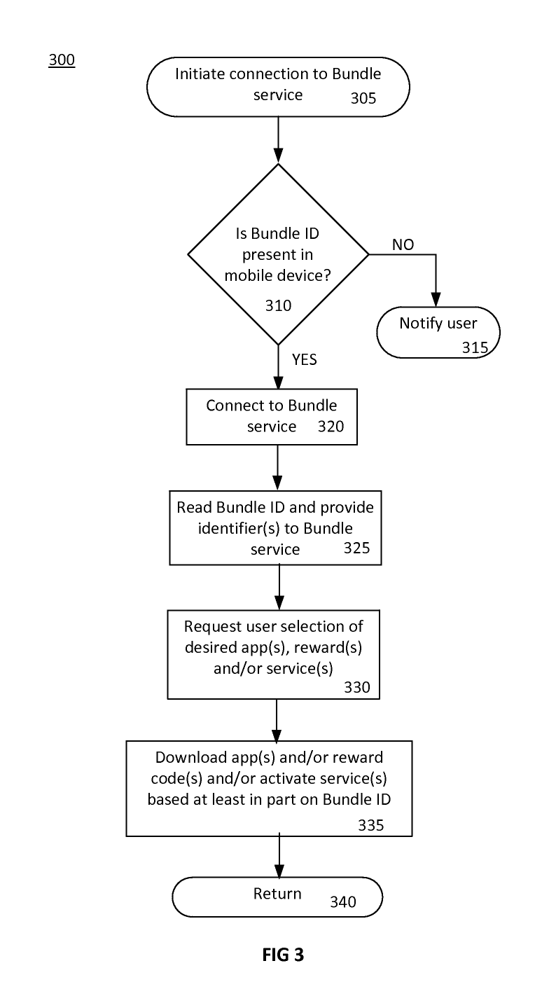

FIG. 3 illustrates a flowchart 300 of exemplary operations consistent with an embodiment of the present disclosure. The operations may be performed, for example, by mobile device 102 and bundle service 108. In particular, flowchart 300 depicts exemplary operations configured to download and store in the mobile device app(s) purchased during the mobile purchase transaction, activate service(s) purchased during the mobile device purchase transaction, download and store in the mobile device reward codes offered and accepted during the purchase transaction and/or receive update offers.

The operations of flowchart 300 may begin by initiating 305 connection to a bundle service. The connection to the bundle service may be initiated in response to power up of the mobile device (e.g., initial power up after the purchase transaction) and/or in response to a user request. For example, the user may receive notice of updated offers (app(s), service(s) and/or reward(s)) available. Whether a bundle ID is present in the mobile device may be determined at operation 310. For example, the bundle ID may be stored in nonvolatile memory included in transponder circuitry of the mobile device. If the bundle ID is not present, the user may be notified at operation 315.

If the bundle ID is present, connection to a bundle service may be established at operation 320. Operation 325 includes reading the bundle ID and providing identifiers to the bundle service. The identifier(s) included in the bundle ID may include app identifier(s), service identifier(s) and/or reward offer identifier(s) as described herein. Operation 330 may include requesting the user to select desired app(s), reward(s) and/or service(s). Additional cost(s), if any, may be communicated to the user, for example, if the cost of selected app(s) and/or service(s) exceeds the amount paid during the purchase transaction plus any associated rewards. The user may then choose to pay the difference or to change selections. Operation 335 includes downloading app(s) and/or reward code(s) based at least in part on the bundle ID. Operation 335 may further include activating service(s) based, at least in part, on the bundle ID. Program flow may return at operation 340.

Thus, the operations of flowcharts 200 and 300 are configured to allow a reseller to sell and a user to purchase app(s) and/or service(s) during a mobile device purchase transaction. The reseller may offer the user reward(s) during the transaction. The purchased app(s) may then be downloaded to the mobile device and the services activated after the purchase transaction. Reward code(s) may also be downloaded.

While FIGS. 2 and 3 illustrate various operations according various embodiments, it is to be understood that not all of the operations depicted in FIGS. 2 and 3 are necessary for other embodiments. Indeed, it is fully contemplated herein that in other embodiments of the present disclosure, the operations depicted in FIGS. 2 and 3 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

Mobile device 102 and purchase system 104 may be configured to communicate with network 106 and/or bundle service 108 using a variety of communication protocols. The communications protocols may include but are not limited to wireless communications protocols, such as NFC, RFID, Wi-Fi, Bluetooth, 3G, 4G and/or other communication protocols. Purchase system 104 may generally be configured to communicate with mobile device 102 using communication protocols configured for generally local communication. The local communication protocols may include but are not limited to NFC, RFID and Bluetooth. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

For example, network 106 may comprise a packet switched network. Mobile device 102 and purchase system 104 may be capable of communicating with the bundle service 108 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, mobile device 102 and purchase system 104 may be capable of communicating with the bundle service 108 using an X.25 communications protocol. The X.25 communications protocol may comply or be compatible with a standard promulgated by the International Telecommunication Union-Telecommunication Standardization Sector (ITU-T). Alternatively or additionally, mobile device 102 and purchase system 104 may be capable of communicating with the bundle service 108 using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, mobile device 102 and purchase system 104 may be capable of communicating with the bundle service 108 using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

“Circuitry”, as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, a system and method consistent with the present disclosure allows a user to purchase selected app(s) and/or service(s) with a mobile device in a mobile device purchase transaction. The user may select app(s) and/or service(s) specific to that user's preferences. The user may be offered reward(s) based on the selections and may thus benefit from reward offer(s) based at least in part on the purchases. Resellers may thus offer more value to a user by offering bundled app and/or service purchases during a mobile device purchase transaction.

The bundle ID is configured to identify the user's selections in the mobile device without requiring power up of the mobile device by the reseller (i.e., without removing the mobile device from its “new, in box” packaging). The purchased app(s) and/or accepted reward offer(s) may then be downloaded and/or purchased service(s) activated after the purchase transaction in response to, for example, mobile device power up and/or a user request.

According to one aspect there is provided a system. The system may include a mobile device and a bundle service. The mobile device may include transponder circuitry configured to receive and store a bundle identifier including an application identifier related to an application. In this example, the bundle identifier may be provided to the transponder circuitry during a transaction that includes purchasing the mobile device and the application. The mobile device may further include memory circuitry configured to receive and store the application after the transaction. Continuing with this example, the bundle service may include a bundle download module configured to provide the application to the mobile device in response to receiving the application identifier from the mobile device.

Another example system includes the forgoing components and further includes a purchase system configured to generate the bundle identifier based, at least in part, on the application identifier.

Another example system includes the forgoing components and the purchase system is further configured to provide the bundle identifier to the transponder circuitry and to cause the transponder circuitry to store the bundle identifier without powering up the mobile device.

Another example system includes the forgoing components and the mobile device is configured to provide the application identifier to the bundle service in response to power up of the mobile device or in response to a user request.

Another example system includes the forgoing components and the bundle identifier comprises a service identifier related to a service purchased during the transaction and the bundle download module is further configured to activate the service in response to receiving the service identifier from the mobile device.

Another example system includes the forgoing components and the bundle identifier comprises a reward identifier related to a reward offered and accepted during the transaction and the bundle download module is further configured to download a reward code to the mobile device in response to receiving the reward identifier from the mobile device.

Another example system includes the forgoing components and the transponder circuitry is an RFID (radio frequency identification) module.

According to another aspect there is provided a method. The method may include storing a bundle identifier in transponder circuitry in a mobile device during a purchase transaction. In this example, the purchase transaction may include purchasing the mobile device and an application, the bundle identifier including an application identifier related to the application. The method may further include downloading the application to the mobile device after completion of the purchase transaction.

Another example method includes the forgoing operations and the bundle identifier further includes a service identifier related to a service purchased during the purchase transaction and the method further includes activating the service after completion of the purchase transaction.

Another example method includes the forgoing operations and the bundle identifier further includes a reward identifier related to a reward offer accepted during the purchase transaction, and the method further includes downloading a reward code associated with the reward offer after completion of the purchase transaction.

Another example method includes the forgoing operations and further includes connecting the mobile device to a bundle service in response to power up of the mobile device, the bundle service configured to provide the application to the mobile device in response to a request from the mobile device, the request comprising the application identifier.

Another example method includes the forgoing operations and further includes connecting the mobile device to a bundle service in response to a user request, the bundle service configured to provide the application to the mobile device in response to a request from the mobile device, the request comprising the application identifier.

Another example method includes the forgoing operations and further includes requesting that the user select at least one of another application and a service for purchase during the purchase transaction; and generating the bundle identifier based at least in part on the user's selection.

Another example method includes the forgoing operations and further includes offering a reward to the user during the purchase transaction.

According to another aspect there is provided a mobile device. The mobile device may include transponder circuitry configured to receive and store a bundle identifier including an application identifier related to an application. In this example, the bundle identifier may be provided to the transponder circuitry during a transaction in response to the mobile device and the application being purchased in the transaction. The mobile device may further include memory circuitry configured to receive and store the application after the transaction.

Another example mobile device includes the forgoing components and the mobile device is configured to request download of the application in response to power up of the mobile device.

Another example mobile device includes the forgoing components and the mobile device is configured to request download of the application in response to a user request.

Another example mobile device includes the forgoing components and the bundle identifier further comprises a service identifier related to a service purchased during the transaction.

Another example mobile device includes the forgoing components and the bundle identifier further comprises a reward identifier related to a reward offered and accepted during the transaction.

Another example mobile device includes the forgoing components and the transponder circuitry is an RFID (radio frequency identification) module.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system comprising:
a mobile device comprising:
transponder circuitry configured to receive and store a bundle identifier comprising an application identifier related to an application, the bundle identifier provided to the transponder circuitry during a transaction comprising purchasing the mobile device and the application, and
memory circuitry configured to receive and store the application after the transaction; and
a bundle service comprising a bundle download module configured to provide the application to the mobile device in response to receiving the application identifier from the mobile device.

2. The system of claim 1, further comprising a purchase system configured to generate the bundle identifier based, at least in part, on the application identifier.

3. The system of claim 2, wherein the purchase system is further configured to provide the bundle identifier to the transponder circuitry and to cause the transponder circuitry to store the bundle identifier without powering up the mobile device.

4. The system of claim 1, wherein the mobile device is configured to provide the application identifier to the bundle service in response to power up of the mobile device or in response to a user request.

5. The system of claim 1, wherein the bundle identifier comprises a service identifier related to a service purchased during the transaction and the bundle download module is further configured to activate the service in response to receiving the service identifier from the mobile device.

6. The system of claim 1, wherein the bundle identifier comprises a reward identifier related to a reward offered and accepted during the transaction and the bundle download module is further configured to download a reward code to the mobile device in response to receiving the reward identifier from the mobile device.

7. The system of claim 1, wherein the transponder circuitry is an RFID (radio frequency identification) module.

8. A method comprising:
storing a bundle identifier in transponder circuitry in a mobile device during a purchase transaction, the purchase transaction comprising purchasing the mobile device and an application, the bundle identifier comprising an application identifier related to the application; and
downloading the application to the mobile device after completion of the purchase transaction.

9. The method of claim 8, wherein the bundle identifier further comprises a service identifier related to a service purchased during the purchase transaction, and further comprising activating the service after completion of the purchase transaction.

10. The method of claim 8, wherein the bundle identifier further comprises a reward identifier related to a reward offer accepted during the purchase transaction, and further comprising downloading a reward code associated with the reward offer after completion of the purchase transaction.

11. The method of claim 8, further comprising connecting the mobile device to a bundle service in response to power up of the mobile device, the bundle service configured to provide the application to the mobile device in response to a request from the mobile device, the request comprising the application identifier.

12. The method of claim 8, further comprising connecting the mobile device to a bundle service in response to a user request, the bundle service configured to provide the application to the mobile device in response to a request from the mobile device, the request comprising the application identifier.

13. The method of claim 8, further comprising:
requesting that the user select at least one of another application and a service for purchase during the purchase transaction; and
generating the bundle identifier based at least in part on the user's selection.

14. The method of claim 8, further comprising offering a reward to the user during the purchase transaction.

15. A mobile device comprising:
transponder circuitry configured to receive and store a bundle identifier comprising an application identifier related to an application, the bundle identifier provided to the transponder circuitry during a transaction in response to the mobile device and the application being purchased in the transaction; and
memory circuitry configured to receive and store the application after the transaction.

16. The mobile device of claim 15, wherein the mobile device is configured to request download of the application in response to power up of the mobile device.

17. The mobile device of claim 15, wherein the mobile device is configured to request download of the application in response to a user request.

18. The mobile device of claim 15, wherein the bundle identifier further comprises a service identifier related to a service purchased during the transaction.

19. The mobile device of claim 15, wherein the bundle identifier further comprises a reward identifier related to a reward offered and accepted during the transaction.

20. The mobile device of claim 15, wherein the transponder circuitry is an RFID (radio frequency identification) module.
